(19) United States
(12) Patent Application Publication
(10) Pub. No.: US 2008/0123523 A1
(43) Pub. Date: May 29, 2008

(54) Loop network system, a device included therein, and a method for determining connecting status of the device to the network

(75) Inventors: Hisatoshi Iwata, Kanagawa (JP); Mutsuya Hida, Kanagawa (JP); Akira Kojima, Kanagawa (JP); Yoshinori Makita, Kanagawa (JP)

Correspondence Address: TOWNSEND AND TOWNSEND AND CREW LLP, TWO EMBARCADERO CENTER, 8TH FLOOR, SAN FRANCISCO, CA, 94111, US

(73) Assignee: Hitachi Global Storage Technologies Netherlands B.V., Amsterdam (NL)

(21) Appl. No.: 11/983,127

(22) Filed: Nov. 6, 2007

(30) Foreign Application Priority Data
Nov. 6, 2006 (JP) 2006-300284

(51) Int. Cl. G06F 11/07

(52) U.S. Cl. 370/222

(57) ABSTRACT

Embodiments in accordance with the present invention relate to determination of a connecting status of a device in a system constituted by a plurality of devices connected via information transmission path in a loop, such as fibre channel arbitrated loop. Particular embodiments of the present invention may help to prevent a bypassed device from performing an improper process at a loop initialization process. According to one embodiment, each device checks its own bypass status at a loop initialization process. The device which has become a loop master determines that it is not bypassed by itself. In an address obtaining step, the device checks whether or not the device itself can actually obtain the address which the device tried to obtain by means of a bit map of the received frame and determines that the device is not bypassed if the address is not obtained. The device checks whether or not the address which has been stored in a predetermined position of a position map exists. If it does not exist, the device determines that it is bypassed.

### CROSS-REFERENCE TO RELATED APPLICATION

The instant nonprovisional patent application claims priority to Japanese Patent Application No. 2006-300284 filed Nov. 6, 2006 and which is incorporated by reference in its entirety herein for all purposes.

### BACKGROUND OF THE INVENTION

Today, interfaces for data storage devices and other devices require increases in the speed of data transfer, the number of devices connected to a host controller, and the connection distance, as the amount of data to be handled has increased exponentially. To satisfy these requirements, systems may employ devices which use an interface called fibre channel arbitrated loop (FC-AL) to transfer data in serial at high speed.

An interconnection of devices in a computer system including a fibre channel arbitrated loop requires some kind of unique electronic addresses or identification information for respective connected devices in order for the respective devices to exchange information (refer to Japanese Patent Publication No. 2000-278299 “Patent Document 1”, for example). The address in the FC-AL is called as an arbitrated loop physical address (AL_PA). Generally, all of the devices connected to the loop network of the FC-AL participate in a loop initialization process at the time of power-on to obtain their AL_PAs. Here, the devices connected to the network include a host controller and the other devices.

In a general FC-AL system, the respective devices constituting the FC-AL system are connected to the loop network via port bypass circuits provided at ports of the respective devices. The port bypass circuit selects either data from the upstream of the loop network or output data at the port of the device to put it on the loop network. Selecting the data from the upstream of the loop network results in bypassing the ports of the devices and selecting the data from the port of the device results in that the device participates in the loop network.

The selecting process of the port bypass circuit is controlled by a port bypass enable signal. The port bypass enable signal can be generally driven by either of the operation by the connected device itself and the operation by an external. A typical example of the port bypass circuit is implemented on a backboard of the FC-AL system or the like. Such a system can be configured so that the port bypass enable signal is driven from the external, for example by the host controller or by manual.

As described above, when the port bypass circuit is controlled by the external other than the device connected thereto, the device to be bypassed cannot directly detect whether or not the device itself is bypassed by the port bypass circuit. The port bypass circuit is configured to select the output to the loop network from either the device or the upper stream of the loop network. Therefore, if the device is bypassed, the input from the loop network is being connected to the port of the device. Thereby, the device recognizes the data going around the loop network as normal even if the device is bypassed.

Although a problem does not occur in a normal I/O process since the host controller does not select bypassed devices, devices bypassed by the port bypass enable signal from the external may carry out the initialization process of the loop in response to input signals from the loop network when the loop initialization occurs. If the speed of the loop initialization process is as slow as the bypassed device can follow, the device can apparently complete the loop initialization process so that it improperly assigns an address to itself.

This means that if a loop initialization occurs in a state that the device is being bypassed, the device may participate in the loop network with an improper address when the bypass of the device is cut. Therefore, it is required to be prevented that the bypassed device obtains the address by completion of the loop initialization.

### BRIEF SUMMARY OF THE INVENTION

Embodiments of the present invention relate to determination of a connecting status of a device in a system constituted by a plurality of devices connected via information transmission path in a loop, such as fibre channel arbitrated loop. Embodiments in accordance with the present invention may prevent a bypassed device from performing an improper process at a loop initialization process. According to the particular embodiment of the present invention of FIG. 5, each device checks its own bypass status at a loop initialization process. The device which has become a loop master determines that it is not bypassed by itself (S22). In an address obtaining step, the device checks whether or not the device itself can actually obtain the address which the device tried to obtain by means of a bit map of the received frame (S23) and determines that the device is not bypassed if the address is not obtained (S24). The device checks whether or not the address which has been stored in a predetermined position of a position map exists (S25). If it does not exist, the device determines that it is bypassed (S26).

### BRIEF DESCRIPTION OF THE DRAWINGS

FIG. 1 is a drawing schematically showing the configuration of the HDD as an example of the devices connected to the FC-AL network.

FIG. 2 is a block diagram schematically showing the configuration of the FC-AL system using the port bypass circuits according to an embodiment.

FIG. 3 is a block diagram schematically showing the configuration of the poll bypass circuit according to an embodiment.

FIG. 4 is a flowchart schematically showing the loop initialization process in the FC-AL network system according to an embodiment.

FIG. 5 is a flowchart showing the method for determining the connection status (bypass status) of the respective HDDs to the network in the loop initialization process of an embodiment.

FIGS. 6(a) and 6(b) are drawings schematically showing the configuration of the bit map and the position map which are used in the FC-AL network according to an embodiment.

FIG. 7 is a flowchart showing the loop initialization process in the FC-AL network system according to an embodiment.

FIG. 8 is a flowchart showing the bypass determining method in the AL_PA obtaining step according to an embodiment.

FIG. 9 is a flowchart showing the bypass determining method in the position map generating step according to an embodiment.

### DETAILED DESCRIPTION OF THE INVENTION

Embodiments of the present invention relate to a loop network system, a device included therein, and a method for determining a connecting status of the device to the network, in particular to determination of a connecting status of a device in a system constituted by a plurality of devices connected via information transmission path in a loop, such as fibre channel arbitrated loop.

A network system according to an aspect of embodiments of the present invention includes a loop network, a plurality of devices connected to the loop network, and a plurality of bypass circuits connected to the plurality of devices respectively, for selecting either one of output data of the connected devices or data from an upstream of the loop network and for outputting the selected data to a downstream of the loop network. Each of the plurality of devices obtains a map including address information from the upstream of the loop network, sets data representing an obtained own address on the loop network to the map, and outputs the map to the connected bypass circuit. Each of the plurality of bypass circuits selects either one of the map outputted by the connected device and the map from the upstream of the loop network and outputs the selected map to the downstream of the loop network. Each of the plurality of devices re-obtains the map from the upstream of the loop network, checks whether or not the map stores the data representing the obtained own address, and determines that the device itself is bypassed if the data representing the obtained own address is not stored. Thus, determining the bypass status using the map by each device can suppress improper processes by the each device.

In one embodiment, each of the plurality of devices sets the data representing the own address to the map by setting a bit in the map to obtain the own address on the loop network. Furthermore, preferably, each of the plurality of devices obtains a second map from the upstream of the loop network, sets the obtained own address on the loop network to the second map, and outputs the second map to the connected bypass circuit. Then, each of the plurality of bypass circuits selects either one of the second map outputted by the connected device and the second map from the upstream of the loop network and outputs the selected second map to the downstream of the loop network. Here, the second map represents an address of each device participating in the loop network by the address and the storing position of the address. And each of the plurality of devices re-obtains the second map from the upstream of the loop network, checks whether or not the second map stores data representing the obtained own address, and determines that the device itself is bypassed if the data representing the obtained own address is not stored. Using two different maps enables more accurate determination of the bypass status.

As another example, the map represents an address of each device participating in the loop network by an address of each of the plurality of devices participating in the loop network and a storing position of the address. And each of the plurality of devices sets the data representing the obtained own address to the map by setting the obtained own address to an indicated position in the map.

In accordance with certain embodiments, each of the plurality of devices may determine that the device itself is not bypassed when the device becomes a loop master in the network system. This achieves more efficient process performing. Also, each different address may be preset to each of the plurality of devices as the obtained addresses on the loop network. This makes the determination of the bypass status by the each device more accurate.

Another aspect of embodiments the present invention is a device connected to a loop network and a bypass circuit which selects either one of output data from a corresponding device and data from an upstream of the loop network and outputs the selected data to a downstream. The device includes a receiver for receiving a map including address information from the upstream of the loop network, an output part for outputting the map to which data representing obtained address of the device on the loop network are set to the connected bypass circuit; and a controller for checking whether the map re-obtained from the upstream of the loop network stores the data representing the obtained address and for determining that the device itself is bypassed by the bypass circuit if the data representing the obtained address is not stored. Determining the bypass status by means of a map enables to suppress erroneous determinations by this device.

Yet another aspect of embodiments of the present invention is a method for determining whether a device is bypassed to a bypass circuit in the device connected to a loop network and the bypass circuit for selecting either one of output data from a corresponding device and data received from an upstream of the loop network and for outputting the selected data to a downstream of the loop network. This method obtains a map including address information from the upstream of the loop network, sets data representing the obtained own address on the loop network to the map and outputting the map to the bypass circuit, checks whether the map re-obtained from the upstream of the loop network stores the data representing the obtained own address, and determines that the device itself is bypassed by the bypass circuit if the data representing the obtained own address is not stored. Determining the bypass status by means of the map like this enables to suppress improper processes by this device.

Embodiments of the present invention can suppress improper processes of the bypassed device due to erroneous recognition of the status of the bypass.

Hereinafter, a preferred embodiment of the present invention is described. For clearness of explanation, the following description and the accompanying drawings contain omissions and simplifications as appropriate. Throughout the drawings, the same components are denoted by like reference numerals, and their repetitive description is omitted if not necessary for the sake of clearness of the explanation. Hereinbelow, a loop network system and components thereof are explained. In the present embodiment, a network system using a fibre channel arbitrated loop (FC-AL) is described as a preferred example of the loop network system. Also, a hard disk drive (HDD) is explained as an example of the devices connected to the FC-AL. The loop network and the respective devices connected to the loop network constitute a network system.

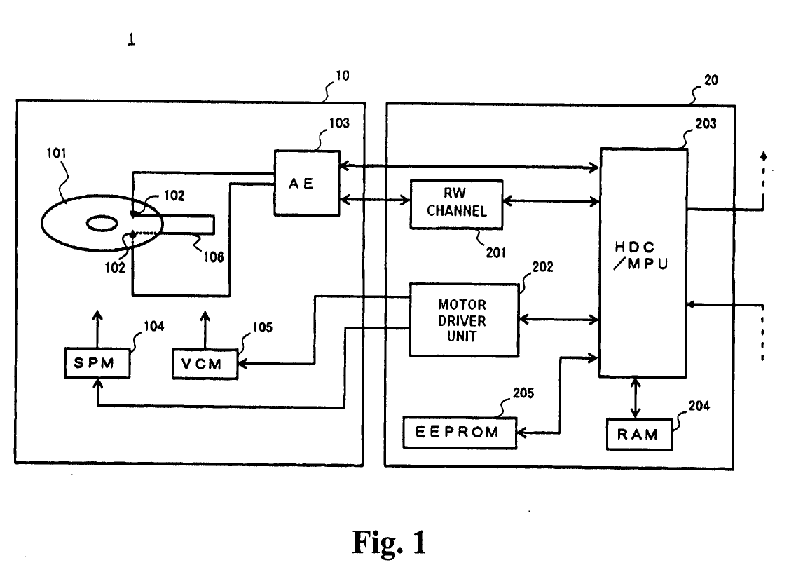

Although the feature of the present embodiment is a determination process of the connection status to a network with respect to HDDs connected to the loop network, the configuration of the HDD is first outlined. FIG. 1 shows a schematic configuration of an entire HDD 1. As shown in FIG. 1, the HDD 1 includes a magnetic disk 101 which is an example of recording disks, head element portions 102, an arm electronics (AE) 103, a spindle motor (SPM) 104, a voice coil motor (VCM) 105, and an actuator 106 in an enclosure 10. The HDD 1 further includes a circuit board 20 fixed outside the enclosure 10. On the circuit board 20, ICs such as a read/write channel (R/W channel) 201, a motor driver unit 202, an integrated circuit (hereafter referred to as HDC/MPU) 203 of a hard disk controller (HDC) and an MPU, a RAM 204, and an EEPROM, and the like.

The SPM 104 rotates the magnetic disk 101 fixed thereto at a predetermined angular rate. The motor driver unit 202 drives the SPM 104 in accordance with control data from the HDC/MPU 203. The magnetic disk 101 of the present embodiment has recording surfaces for recording data on both surfaces thereof, and head element portions 102 corresponding to the respective recording surfaces are provided. Respective head element portions 102 are fixed to sliders (not shown) and the sliders are fixed to the actuators 106. The sliders fly over the rotating magnetic disk 101. The actuators 106 are coupled to the VCM 105 and pivots around a pivotal axis to move the head element portions 102 (and sliders) in the radial direction of the magnetic disk 101 over the rotating disk.

The motor driver unit 202 drives the VCM 105 in accordance with the control data from the HDC/MPU 203. The head element portions 102 typically contain write elements for converting electric signals to magnetic fields according to write data, and read elements converting magnetic fields from the magnetic disk 101 to electric signals. At least one piece of the magnetic disk 101 is enough and a recording surface can be formed on either surface or both of the magnetic disk 101. The AE 103 selects one head element portion 102 for data accessing from the plurality of head element portions 102, amplifies a reproduction signal reproduced by the selected head element portion 102 by a predetermined gain, and sends it to the R/W channel 201. The AE 13 also sends a recording signal from the R/W channel 201 to the selected head element portion 102.

In a writing process, the R/W channel 201 modulates codes of the write data supplied from the HDC/MPU 203, converts the code-modulated write data to the write signal, and supplies it to the AE 103. In a reading process, the RW channel 201 amplifies the read signal supplied from the AE 103 to have a predetermined amplitude, extracts data from the obtained read signal, and carries out a decoding process. The data to be read out contain user data and servo data. The decoded read user data is supplied to the HDC/MPU 203.

With regard to the HDC/MPU 203, the MPU operates in accordance with micro codes loaded in the RAM 204. Starting up of the HDD 1, data required for controlling and data processing as well as micro codes working on the MPU are loaded from the magnetic disk 11 or a ROM within the HDC/MPU 203 to the RAM 204. The HDC is configured as a logic circuit and carries out various processes integrally with the MPU. The HDC/MPU 203 carries out necessary processes concerning data process, such as order management of command execution, positioning control of the head element portions 102 utilizing servo data, interface control, and defect management, etc. The HDC/MPU 203 of the present embodiment particularly performs interface processes and inner processes in the loop network in which the HDD 1 participates.

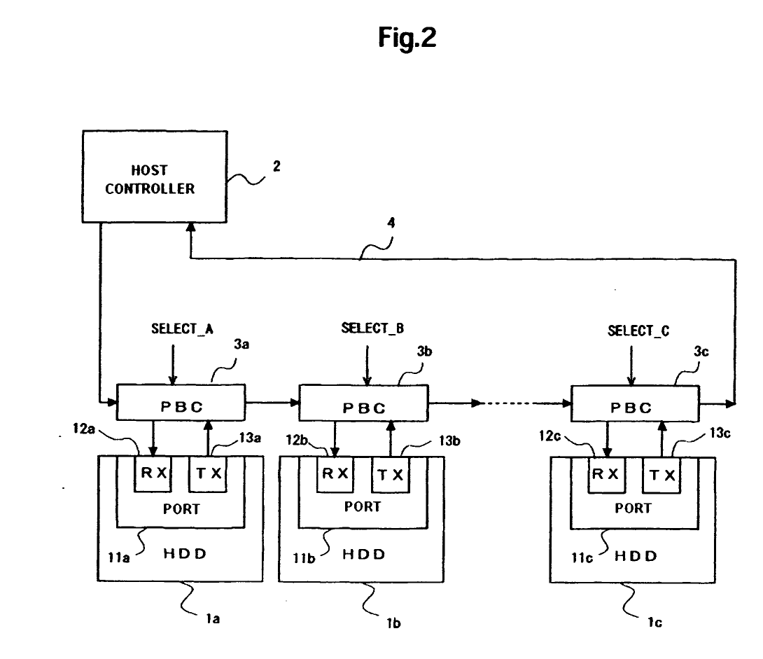

FIG. 2 is a block diagram schematically showing the FC-AL system according to the present embodiment. The FC-AL network system includes an FC-AL network 4 as an example of the loop networks, a host controller 2 and a plurality of HDDs 1a-1c as examples of devices connected to the FC-AL network 4. The FC-AL network further includes a plurality of port bypass circuits (PBC) 3a-3c. FIG. 2 exemplifies three HDDs and port bypass circuits.

The respective HDDs 1a-1c contain ports 11a-11c as interfaces of the FC-AL network and the respective ports 11a-11c contain receivers (RX) 12a-12c as examples of receiving parts and transmitter (TX) 13a-13c as examples of transmitting parts. The HDC/MPUs 23 of the respective HDDs 1a-1c function as ports 11a-11c.

The HDDs 1a-1c are connected to the FC-AL network 4 via the port bypass circuits 3a-3c respectively. That is, the port bypass circuit 3a is connected to the port 11a of the HDD 1a, the port bypass circuit 3b is connected to the port 11b of the HDD 1b, and the port bypass circuit 3c is connected to the port 11c of the HDD 1c. The port bypass circuits 3a-3c bypasses the ports 11a-11c of the HDDs 1a-1c or make the ports 11a-11c of the HDDs 1a-1c participate in the FC-AL network 4.

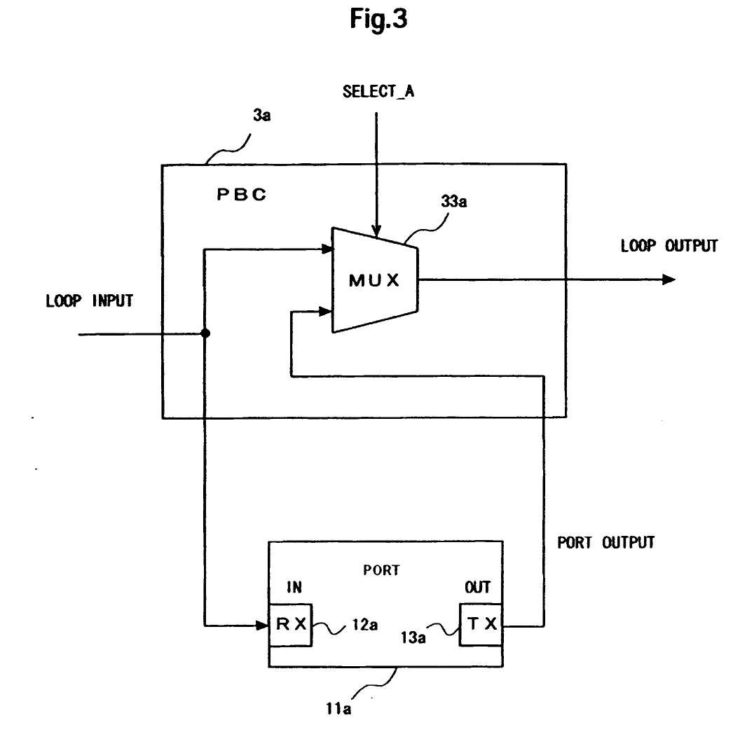

The port bypass circuits 3a-3c are circuits which select either the input from the upstream of the FC-AL network 4 or the outputs of the ports 11a-11c of the respective HDDs to put it out to the downstream of the FC-AL network 4. FIG. 3 is a block diagram schematically showing the configuration of the port bypass circuit 3a. The other port bypass circuits are configured similarly. The port bypass circuit 3a contains a multiplexer (MUX) 33a. The multiplexer 33a selects either the input data LOOP INPUT from the upstream of the FC-AL network 4 or the output data PORT OUTPUT from the port 11a to transfer it as output data LOOP OUTPUT to the downstream of the FC-AL network 4.

Which data (signal) the multiplexer 33a selects is decided depending on a port bypass enable signal SELECT_A. When the port bypass enable signal SELECT_A is 0, the multiplexer 33a selects the output of the port 11a PORT OUTPUT and outputs it to the downstream of the FC-AL network 4 as the output signal LOOP OUTPUT to let the port 11a participate in the loop. On the other hand, when the port bypass enable signal SELECT_A is 1, the multiplexer 33a selects the input signal from the FC-AL network 4 LOOP INPUT and outputs it as the output signal LOOP OUTPUT to the FC-AL network 4 to bypass the port 11a of the HDD 1a.

The port bypass enable signal SELECT_A can be generally driven by either one of the operation of the connected HDD 1a itself or the operation of the external. In the example of FIGS. 2 and 3, the respective port bypass circuits 3a-3c are controlled by the control signals from the external SELECT_A-SELECT_C. Typically, the port bypass circuits 3a-3c are implemented on a backboard of the FC-AL system or the like. The system may be configured so that the host controller 2 operates the port bypass enable signals SELECT_A-SELECT_C or they are operated manually.

As described above, in such a system that the respective devices constituting the FC-AL system are connected to the FC-AL network via external bypass circuits provided at respective ports of the respective devices, the respective devices cannot determine whether or not there exist bypasses controlled by the external. Thus, in the loop initialization process to assign the network addresses on the FC-AL network, the bypassed device may apparently complete the loop initialization process so that it improperly obtains an address. As a result, the device may participate in the loop network with the improper address when the bypass to the device is disconnected.

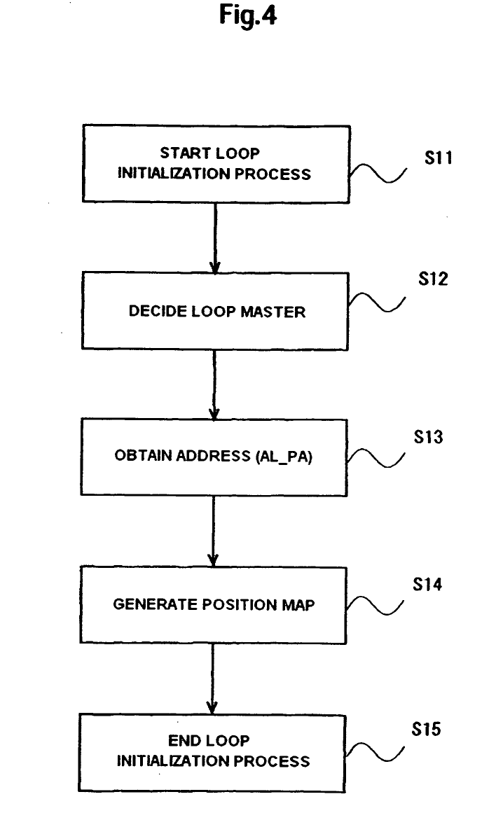

In the loop initialization process, the respective HDDs 1a-1c of the present embodiment determine the connection status to the FC-AL network 4, i.e., whether or not there exist bypasses by the port bypass circuits 3a-3c. Thereby, it is prevented that the bypassed HDD carries out an apparent proper loop initialization process to obtain the improper address. Although the loop initialization process is defined in the FC-AL standard, the process is roughly divided into the steps in the flow of FIG. 4.

That is, the loop initialization process includes the following steps: the loop initialization starting step S11, the loop master determining step S12, the address (arbitrated loop physical address: AL_PA) obtaining step S13, the position map generating step S14, and the loop initialization ending step S15. In this embodiment, the respective HDDs 1a-1c perform the following methods in the loop initialization process to detect the connection status (bypass status) of the ports 11a-11c of themselves and prevent themselves from improperly obtaining addresses. Here, the ports 11a-11c of the respective HDDs 1a-1c, i.e., the HDC/MPUs 203, carry out the following processes.

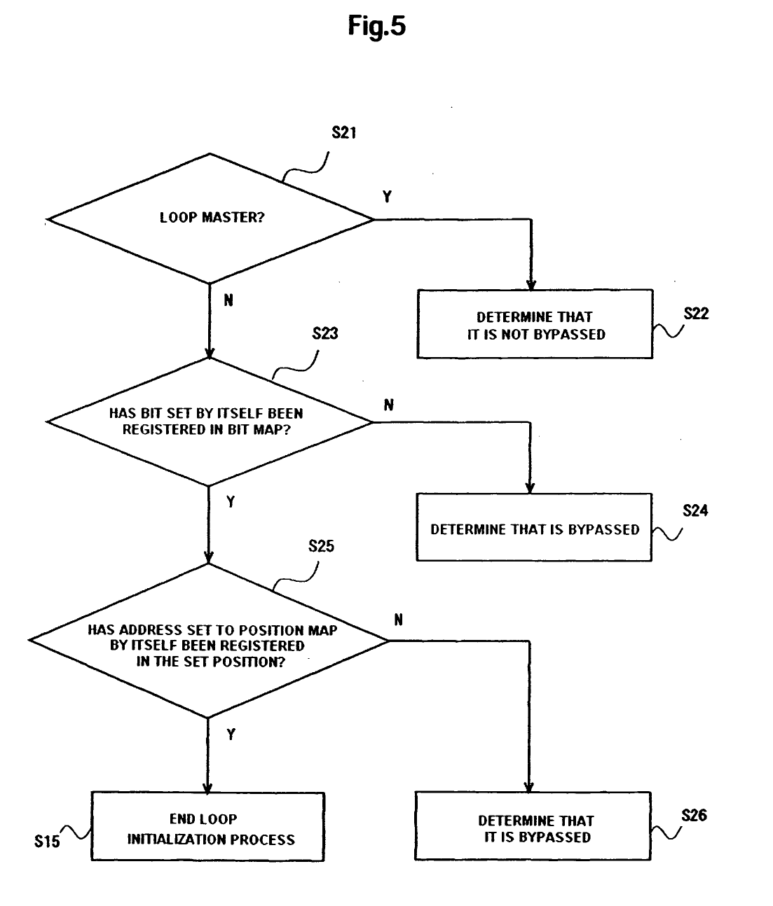

Hereafter, the method for determining the connection status of the respective devices at the initialization process is explained, referring to the flowcharts of FIGS. 4 and 5. First, at the loop master determining step S12, the FC-AL system determines the device to be the loop master from all of the devices including the host controller 2 and the HDDs 1a-1c by the same method as defined in the FC-AL standard. The HDDs which are bypassed cannot ever be the loop master because their output signals are not put out on the FC-AL network 4. Therefore, the HDD which has become the loop master determines that it in itself is not bypassed (S22), according to the determination that the HDD itself is the loop master (Y at S21). The device which has become the loop master carries out the loop initialization process as usual. On the other hand, the HDDs which have become non-loop masters carry out the following processes.

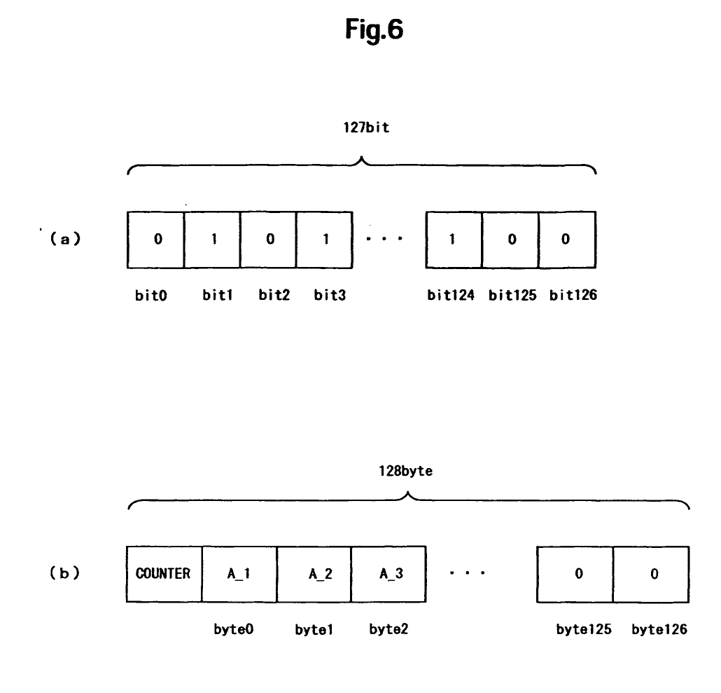

The non-loop master HDDs (N at S21) check by means of received bit maps whether or not the addresses i.e., AL_PAs which they tried to obtain at the following address (AL_PA) obtaining step S13 have been actually obtained (S23). Here, the bit map is an example of the maps containing address information and is defined in the FC-AL standard. As shown in FIG. 6(a), the bit map is 127-bit length of data where each bit corresponds one-to-one to the AL_PA and the 127 bits different in bit position (bit0 to bit126 in the example of FIG. 6(a)) correspond to 127 AL_PAs, respectively. The each device sets a bit at any bit position (sets 1 in the example of FIG. 6(a)) to obtain the AL_PA. The method for circulating the bit map is described later in detail.

When the bit set by the device itself is not set in the received bit map, i.e., when its own AL_PA is not set (N at S23), it means that the bit map transmitted for obtaining the AL_PL was not put out on the loop, the device determines that the device itself is bypassed (S24).

The HDD which has determined that the HDD itself is bypassed issues a signal for starting the loop) initialization, when the bypass is disconnected afterward and it participates in the FC-AL network 4. Thereby the HDD can retry the loop initialization. However, if the HDD has been set not to start the loop initialization by itself, the HDD sets the AL_PA at an invalid value not to carry out I/O processes in the FC-AL network until the other device starts the loop initialization even if the bypass is disconnected.

The HDD which does not determine that it is bypassed with checking the bit it set by itself at the address (AL_PA) obtaining step S13 (Y at S23) checks whether or not its own AL_PA is correctly recorded in the position map (S25) at the following position map generating step S14. Here, the position map is an example of the maps containing address information and it is data for storing the addresses of the devices participating in the FC-AL network as shown in FIG. 6(b). The loop master registers its own AL_PA in the position map and circulates it around the FC-AL network 4.

The respective devices connected to the FC-AL network set their own obtained AL_PAs to the circulating position map and transfer it. The position map contains a counter field (COUNTER) and the respective devices set their AL_PAs at the byte positions indicated by the counter and increment the counter. Thereby, from the upstream starting from the loop master, the respective devices sequentially store their own AL_PAs at the top of the empty byte positions. That is, the respective positions for storing the AL_PAs correspond to the relative positions of the respective devices participating in the network starting from the loop master. Specifically, the loop master sets its AL_PA at byte0 and increments the counter. The next downstream device sets its AL_PA at byte1.

When the position map returns, the loop master circulates the position map again on the FC-AL network 4. This results in the respective devices to know the AL_PAs of the respective devices on the FC-AL network 4. Here, the position map is data of 128-byte length at maximum and it is defined in the FC-AL standard. The position map and the method for circulating thereof are described later in detail.

The respective HDDs remember their own registration positions at the position map when they set their AL_PAs to the position map and transfer it. The each HDD checks whether or not its own AL_PA exists at the registered position in the position map received later (S25). If the AL_PA does not exist (N at S25), it means that the position map transmitted with the AL_PA was not put out on the loop. Therefore, the HDD determines that the HDD itself is bypassed by the port bypass circuit (S26).

The HDD which has determined that the HDD itself is bypassed can retry the loop initialization by issuing a signal for starting the loop initialization when the bypass is disconnected afterward and it participates in the FC-AL network. However, if the HDD has been set not to start the loop initialization by itself, the HDD does not carry out I/O processes in the loop by setting the AL_PA at an invalid value even if the bypass is disconnected until the other device starts the loop initialization. The HDD which has not determined that it is bypassed by finding its own address in the position map (Y at S25) goes to the loop initialization ending step S15 to carry out the loop initialization ending process and make the obtained AL_PA valid.

According to the above method, the HDD on the loop can detect the bypass status of itself. This prevents the bypassed devices from obtaining improper addresses at the loop initialization process and participating in the loop network with the improper addresses after the bypass is disconnected. As described above, the respective HDDs preferably determine the bypass status at the respective steps of the loop master determining step S12, the address obtaining step on the network S13, and the position map generating step S14. However, the respective HDDs may perform the determination process at either the address obtaining step S13 or the position map generating step S14 and skip the determination process at the other step and the loop master determining step S12.

Here, the position map generating step S14 is optional in the FC-AL standard and may be omitted depending on the system. In this case, the respective devices are required to carry out the determination of the connection status reliably at the AL_PA obtaining step S13. However, if the non-bypassed device at the downstream obtains the same AL_PA as the bypassed device at the upper stream at the AL_PA obtaining step S13, the bypassed device cannot accurately determine that it is bypassed.

This is because the bypassed device at the upper stream and the non-bypassed device at the downstream can set the same bit in the obtained bit map and the bypassed device at the upper stream finds that the same bit as the one it set by itself is registered in the obtained bit map afterwards. In order to deal with such a status, the AL_PAs to be obtained are preferably preset to the respective devices such as by jumper switches or the like, so that the respective devices obtain different AL_PAs from each other. If the AL_PAs obtained by the respective devices are different, the devices can correctly determine the bypass status. Here, the devices at the downstream at the loop initialization denote all of the connected devices from the next device of itself to the loop master along the transmission direction of the loop.

Preliminarily fixing the AL_PAs to be obtained by the respective devices to different AL_PAs is preferable in the other points. When the FC_AL system performs the position map generating step S14 as an option, the device sometimes cannot correctly determine the bypass status at this step. This is the case that the device connected to the nearest downstream position to the bypassed HDD (the next device of the downstream side) obtains the same AL_PA as the one obtained by the bypassed device.

The device at the upstream cannot perform the correct bypass determination because the HDD at the upstream and the device at the downstream respectively perform the same process, that is, they set the same AL_PA to the same position. It can be handled by that the respective devices are preset to obtain different AL_PAs by jumper switches or the like. In case of handling by other methods or a system for which such an above case is not needed to consider, the AL_PAs to be obtained by the respective devices do not need to be preliminarily fixed to different addresses.

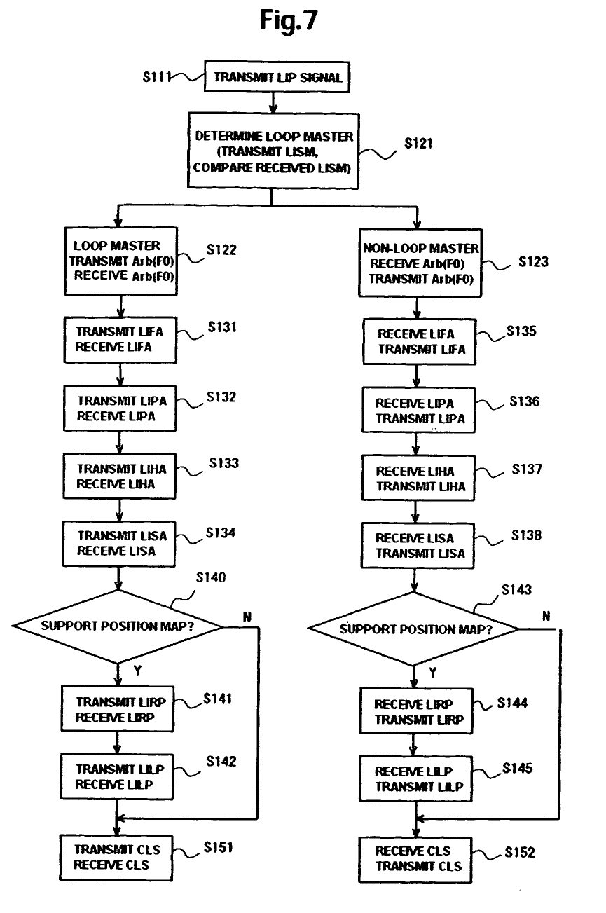

Hereinafter, the loop initialization process according to the present embodiment is described. FIG. 7 is a flowchart illustrating the entire process steps of the loop initialization process. The loop initialization process is started by that a port of at least one device transmits a loop initialization primitive (LIP) sequence set after the system is powered on or the system is reset (S111). Respective ports which have received the transmitted LIP sequence set start the loop master determining process (S121).

Specifically, a loop initialization select master (LISM) frame for controlling the frame to be handled in the loop initialization process is generated and transmitted. Each port for generating the LISM frame has a world-wide identification number of the fibre channel (world-wide name) as a part of the frame. When each port receives the LISM frame, it compares the identification number in the frame with its own identification number. If it has a smaller number of identification number than the one in the LISM frame, the device replaces the identification number in the frame with its own identification number and transmits the changed LISM frame to the next port at the downstream.

If the receiving port has a larger number of identification number than the one in the LISM frame, the device transmits the unchanged LISM frame to the next device. Conclusively, all of the LISM frames include the single smallest identification number in the all ports connected to the loop. And the port having the smallest identification number becomes the loop master. The loop master transmits an Arb signal to notify that the LISM process has been completed to the respective ports on the loop (S122), and the other ports transfers the LISM received from the upstream to the downstream (S1123). The device which has become the loop master determines that it is not bypassed and then carries out the loop initialization process as usual.

Next, the address obtaining process S13 and the bypass determining process therein are described. As shown in FIG. 7, the port of the device which has become the port master next generates a series of frames to determine the AL_PA of the port on the loop. The each frame is separated into a frame identification part and a bit map containing address information. As described above, the bit map contains 127 bits of numeric values and each bit corresponds to one AL_PA. Each port sets a flag to the bit corresponding to the AL_PA which it wants to obtain in accordance with the rule described below and transmits the frame to the subsequent port. When the frame returns to the port of the loop master in this way, the port of the loop master replaces the frame identification part without changing the address information part according to the rule to transmit the frame to the subsequent port in the flow.

First, the port which has become the loop master generates a loop initialization fabric assigned (LIFA) frame and transmits it to the port at downstream (S131). The other ports set the AL_PAs assigned by the fibre channel fabric prior to the loop initialization in execution, if any, and transmit the frame to the subsequent port (S135). Next, the port of the loop master replaces the frame identification part with a loop initialization previous acquired (LIPA) address frame and transmits it to the subsequent port (S132). The each port sets flags corresponding to the AL_PA received prior to the loop initialization in execution, if any, and transmits the frame to the subsequent port (S136).

Next, the port which has become the loop master replaces the frame identification part with a loop initialization hard assigned (LIHA) frame and transmits it to the subsequent port (S133). The other ports perform necessary processes and transfer the frame to the subsequent ports (S137). If the loop initialization is the first loop initialization at the all ports on the loop, any bit is not set in the address information part of the LIHA frame at all. When each port receives the LIHA frame, it sets the bit corresponding to its hard address to the 127-bit address information part. If the corresponding bit has already been set, the port tries to obtain the AL_PA by soft addressing described next.

Next, the port of the loop master replaces the frame identification part with a loop initialization soft assigned (LISA) frame and transmits it to the subsequent port (S134). The other ports perform necessary processes and transfer the frame to the subsequent ports (S138). When the each port receives the LISA frame, if it could not select the address during the processes until receiving the above-described LIHA frame, it selects any available loop address referring to the address information part and sets the available bit to the 127-bit address number in the frame and then transmits the frame to the next port.

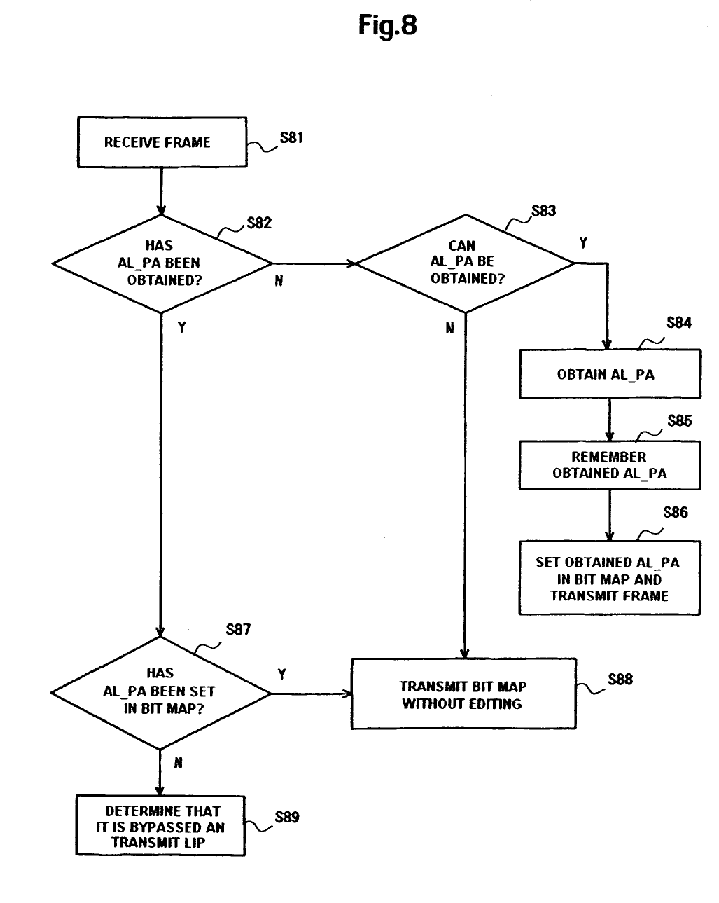

Here, referring to FIG. 8, the bypass status determining method at the address (AL_PA) obtaining step S13 in the loop initialization process is described. The process flow of the FIG. 8 is applied only to the non-loop master devices. Also, FIG. 8 illustrates the process flow in any one phase of the above-described LIFA, LIPA, LIHA, LISA phases. As described above, the respective phases are defined in the FC-AL standard and the loop master circulates the bit map to all of the devices on the loop once in each phase so that the respective devices obtain their own AL_PAs in any one of the phases.

Now referring to FIG. 8, the preferred embodiment of the present invention with the address (AL_PA) obtaining step S13 is explained. When the each port (device) receives the frame where the bit map is contained (S81), it determines whether or not the AL_PA has been obtained (S82). If the AL_PA has not been obtained yet (N at S82), the following processes are the same as in the conventional technique. That is, the port determines whether or not the AL_PA can be obtained (S83) and if AL_PA cannot be obtained (N at S83), it stores the bit map in the frame without changing and transmits the frame (S88). If the AL_PA can be obtained (Y at S83), the port obtains the AL_PA (S84), remember it (S85), stores the bit map to which the bit corresponding to the obtained AL_PA is set in the frame, and transmits the frame (S86). Here, the determination whether or not the AL_PA can be obtained (S83) is to determine the kind of the phase in execution and to check whether the bit corresponding to the AL_PA which it is trying to obtain is available on the bit map.

On the other hand, the AL_PA has already been obtained at the AL_PA obtaining determination (Y at S82), the port checks whether the bit corresponding to the obtained AL_PA is set in the received bit map (S87). If it is set (Y at S87), the port stores the bit map in the frame without changing it and transmit the frame as in the conventional technique (S88). If it is not set (N at S87), the port determines that it is bypassed and issues the LIP to start the loop initialization (S89)

The feature of the process flow of FIG. 8 is that the port checks whether or not the obtained AL_PA is set in the received bit map (S87) and if it is not set, it determines that the port itself is bypassed and starts the loop initialization (S89). Thus, the respective ports (devices) do not obtain addresses improperly during being bypassed.

Next, the address map generating process is described. As shown in FIG. 7, the port of the loop master determines by means of the returned LISA frame whether or not all of the ports on the loop support a loop position map (S140). The other ports perform the same process (S143). If any port which does not support exists on the loop, the loop master transmits a CLS signal (S151). The port which has received the CLS signal transmits the CLS signal to the subsequent port (S152). When the CLS signal returns to the loop master, the loop initialization process is completed.

If all of the ports support the loop position map (Y at S140), the port of the loop master newly generates a loop initialization report position (LIRP) frame, sets its own information to it, and transmits it to the subsequent port (S141). This frame contains a frame identification part and a position map indicating the 128-byte AL_PA information. The position map has been explained with referring to FIG. 6(b). The first byte is a counter indicating the port offset number on the loop, and the AL_PAs which have actually been obtained by the respective ports are set to the second and the following bytes. The port which has received the LIRP sets the obtained AL_PA to the position corresponding to the port offset number and transmits the frame to the subsequent port. If the AL_PA has not been obtained, it transmits the received LIRP to the subsequent port as it is (S144). Here, another way can be considered that the port transmits the LIP before generating the position map to retry the loop initialization, if the AL_PA has not been obtained.

Next, the port of the loop master replaces the frame identification part of the returned LIRP frame with the loop initialization loop position (LILP) and transmits the frame to the subsequent port (step S142). The other ports perform the necessary processes and transmit the frame to the subsequent ports (S145). Referring to the LILP containing the position map enables that the respective ports figure out the number of the port participating in this loop initialization process, the AL_PA of the port being the loop master, and the order of the AL_PAs of the subsequent ports thereof. When the LILP finally returns to the port of the loop master, as already described above, the port of the loop master transmits the CLS signal (S151). The CLS signal circulates around the loop (S152), and the loop initialization process is ended when the CLS signal returns to the loop master.

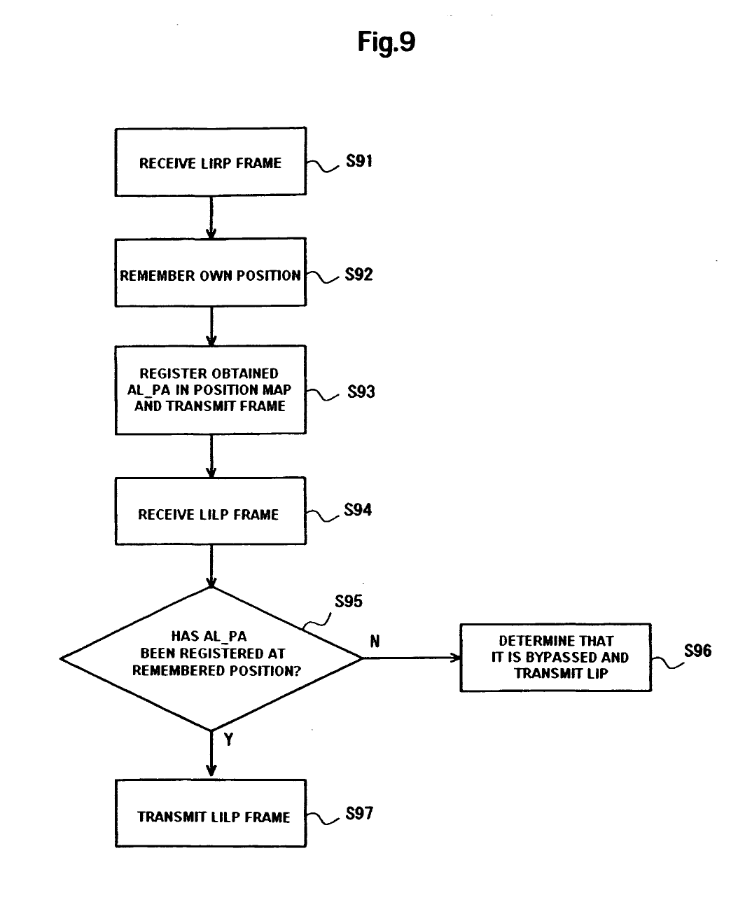

The method for determining bypass at the position map generating step S14 is described referring to FIG. 9. However, if the position map generating step S14 is not omitted at the loop initialization process, the method is applied to the ports of the non-loop masters (devices) as in FIG. 8. The embodiment of the present invention at the position map generating step S14 is explained referring to FIG. 9.

First, a port receives an LIRP frame (S91). The LIRP frame, which is defined in the FC-AL standard as described above, circulates around all of the devices on the loop starting from the loop master, sequentially collects the AL_PAs of the respective devices, and generates the position map. The port refers to the position map contained in the received LIRP frame, remembers the position to register its own AL_PA (S92), stores the position map where its own AL_PA is registered in the LIRP frame, and transmits the frame (S93).

Thereafter, the port receives an LILP frame (S94). As described above, the LILP frame is defined in the FC-AL standard and it circulates around all of the devices on the loop starting from the loop master and informs the respective devices of the completed position map. The port refers to the position map stored in the received LILP frame and checks whether or not its own AL_PA exists at the position remembered at step S92 (S95). If it exists, the port transmits the LILP frame as in the conventional technique (S97). If not, it determines that it is bypassed and issues the signal LIP to start the loop initialization (S96).

The feature of the process flow of FIG. 9 is to check whether its own AL_PA is registered to the correct position of the received position map (S95) and to determine that the port itself is bypassed to start the loop initialization if it is not registered correctly (S96). This prevents the device from improperly obtaining the address during being bypassed.

As set forth above, the present invention is described by way of the preferred embodiments but is not limited to the above embodiments. A person skilled in the art can easily modify, add, and convert the each element in the above embodiments within the scope of the present invention. For example, the present invention is preferable to the FC-AL network system including data storage devices such as HDDs, but is applicable to other devices or systems using other protocols.

What is claimed is:

1. A network system comprising:
a loop network;
a plurality of devices connected to the loop network; and
a plurality of bypass circuits connected to the plurality of devices respectively, for selecting either one of output data of the connected devices or data from an upstream of the loop network and for outputting the selected data to a downstream of the loop network; wherein
each of the plurality of devices obtains a map including address information from the upstream of the loop network, sets data representing an obtained own address on the loop network to the map, and outputs the map to the connected bypass circuit,
each of the plurality of bypass circuits selects either one of the map outputted by the connected device and the map from the upstream of the loop network, and outputs the selected map to the downstream of the loop network, and
each of the plurality of devices re-obtains the map from the upstream of the loop network, checks whether or not the map stores the data representing the obtained own address, and determines that the device itself is bypassed if the data representing the obtained own address is not stored.

2. The network system according to claim 1, wherein each of the plurality of devices sets the data representing the own address to the map by setting a bit in the map to obtain the own address on the loop network.

3. The network system according to claim 1, wherein
the map represents an address of each device participating in the loop network by an address of each of the plurality of devices participating in the loop network and a storing position of the address, and
each of the plurality of devices sets the data representing the obtained own address to the map by setting the obtained own address to an indicated position in the map.

4. The network system according to claim 2, wherein
each of the plurality of devices obtains a second map from the upstream of the loop network, sets the obtained own address on the loop network to the second map, and outputs the second map to the connected bypass circuit,
each of the plurality of bypass circuits selects either one of the second map outputted by the connected device and the second map from the upstream of the loop network, and outputs the selected second map to the downstream of the loop network,
the second map represents an address of each device participating in the loop network by the address and the storing position of the address, and
each of the plurality of devices re-obtains the second map from the upstream of the loop network, checks whether or not the second map stores data representing the obtained own address, and determines that the device itself is bypassed if the data representing the obtained own address is not stored.

5. The network system according to claim 1, wherein each of the plurality of devices determines that the device itself is not bypassed when the device becomes a loop master in the network system.

6. The network system according to claim 1, wherein each different address is preset to each of the plurality of devices as the obtained addresses on the loop network.

7. A device connected to a loop network and a bypass circuit which selects either one of output data from a corresponding device and data from an upstream of the loop network, and outputs the selected data to a downstream of the loop network, the device comprising:
a receiver for receiving a map including address information from the upstream of the loop network;
an output part for outputting the map to which data representing obtained address of the device on the loop network are set to the connected bypass circuit; and
a controller for checking whether the map re-obtained from the upstream of the loop network stores the data representing the obtained address and for determining that the device itself is bypassed by the bypass circuit if the data representing the obtained address is not stored.

8. The device according to claim 7, wherein the map includes a plurality of bits and the device sets the data representing the obtained address by setting one of the plurality of bits.

9. The device according to claim 7, wherein the map represents an address of the each device participating in the loop network by an address of the device participating in the network and a storing position of the address,
the device sets the data representing the obtained own address to the map by setting the obtained own address to the position indicated on the map.

10. The device according to claim 8, wherein the device obtains a second map from the upstream of the loop network, sets the obtained own address on the loop network to the second map, and outputs the second map to the connected bypass circuit,
the second map represents an address of each device participating in the loop network by the address and the storing position of the address, and
the controller re-obtains the second map from the upstream of the loop network, checks whether or not the second map stores the obtained own address, and determines that the device itself is bypassed if the obtained own address is not stored.

11. A method for determining whether a device is bypassed to a bypass circuit in the device connected to a loop network and the bypass circuit for selecting either one of output data from a corresponding device and data received from an upstream of the loop network and for outputting the selected data to a downstream of the loop network, the method comprising:
obtaining a map including address information from the upstream of the loop network;
setting data representing the obtained own address on the loop network to the map and outputting the map to the bypass circuit;
checking whether the map re-obtained from the upstream of the loop network stores the data representing the obtained own address; and
determining that the device itself is bypassed by the bypass circuit if the data representing the obtained own address is not stored.
